(19) United States
(12) Patent Application Publication
(10) Pub. No.: US 2006/0042655 A1
(43) Pub. Date: Mar. 2, 2006

(54) Tip cleaning device

(76) Inventor: Robert A. Beatty, Oak Brook, IL (US)

Correspondence Address: BRINKS HOFER GILSON & LIONE, P.O. BOX 10395, CHICAGO, IL, 60610, US

(21) Appl. No.: 10/930,222

(22) Filed: Aug. 31, 2004

(51) Int. Cl. B08B 1/00

(52) U.S. Cl. 134/6; 15/210.1; 15/218.1

(57) ABSTRACT

One embodiment of this invention is a cleaning device comprising a base including an upper surface and a lower surface; and an upstanding wall extending upwardly relative to the upper surface of the base. The upstanding wall includes a first surface and a second surface, wherein the first surface includes an abrasive material disposed thereon and the second surface does not include an abrasive material. A thickness of the wall is configured to be less than about 3 mm.

### BACKGROUND OF THE INVENTION

1. Field of Invention

The invention relates to a tip cleaning device for electro-cautery instruments such as a bipolar cautery. More particularly, the invention relates to a tip cleaning device for a bipolar cautery that can protect bipolar cautery tips from deformation and damage that arise out of tip cleaning.

2. Description of the Prior Art

Electro-cautery instruments are generally well known and widely used in various medical fields. Among the electro-cautery instruments, a bipolar cautery is frequently used to cut tissues or stop bleeding. The bipolar cautery generally has the shape of a forceps or a pincer. The bipolar cautery typically has a pair of legs and each leg includes a tip on its end. Electrical current flows from one tip to the other tip to cauterize the tissues.

Normally, the bipolar cautery mentioned above is not disposable and used repeatedly with sterilization before each use. It is, therefore, important to maintain the bipolar cautery in good condition for the repeated uses. Particularly, the tips of the bipolar cautery must be clean and maintain a perfect opposition. Cleaning of the tips is performed using conventional tip cleaners, such as Deven® Tipolisher™ marketed by Kendall-LTP. During such cleaning, the bipolar cautery tips may be deformed and damaged.

FIG. 1 shows one type of a prior art tip cleaner, a cleaning pad 10. The cleaning pad 10 has an abrasive layer 12 made of abrasive material, such as sandpaper, on its top surface. To clean tips 14, 16 of bipolar cautery 18, a surgeon drags the tips 14, 16 across the top surface of the abrasive layer 12. By dragging the tips, the tips are easily torqued and become permanently bent, so that they no longer meet accurately to grasp tissues in need of cautery.

Besides the disadvantages of causing tip deformations, the cleaning pad 10 is unable to clean inner surfaces of the tips 14, 16. Instead, the inner surfaces of the tips 14, 16 are cleaned via another type of well-known pad 20 as shown in FIG. 2. A surgeon folds the pad 20 to form a bulky ridge 22 and rubs the tip inner surfaces against both sides of the bulky ridge 22. During this movement, the tips 14, 16 are often distorted and bent out due to nonaxial contact between the tips 14, 16 and the cleaning pad 20. As a result, a surgeon is unable to reuse the bipolar cautery 18 after using them only a few times.

Furthermore, where a large amount of blood is involved with surgery, the pads 10, 20 do not appropriately perform the tip cleaning. A surgeon needs to resort to additional cleaning methods. In addition, the pads 10, 20 tend to perform excessive or unnecessary cleaning of the tips. Because the electric current normally flows from one tip to the other tip, blood or tissues typically stick to only one tip. It is in part because one tip produces more heat than the other tip. The pads 10, 20 do not differentiate between the two tips 14, 16 despite the fact that only one tip generally requires cleaning. As a result, tip cleaning with the pads 10, 20 inevitably exposes the tips 14, 16 to undesirable abrasion. Accordingly, there is a need for a tip cleaning device for a bipolar cautery that overcomes these drawbacks.

### BRIEF SUMMARY OF THE INVENTION

One aspect of the invention provides a cleaning device including a base having an upper surface and a lower surface; and an upstanding wall extending upwardly relative to the upper surface of the base. The upstanding wall includes a first surface and a second surface, wherein the first surface includes an abrasive material disposed thereon and the second surface does not include an abrasive material. A thickness of the wall is configured to be less than about 3 mm.

The above aspect of the invention provides several advantages, such as protecting tips of various devices from deformation and damage arising out of the cleaning process and lengthening service life of the devices.

### BRIEF DESCRIPTION OF SEVERAL VIEWS OF THE DRAWINGS

FIG. 1 depicts a bipolar cautery tip cleaning by using a conventional pad.

FIG. 2 depicts a bipolar cautery tip cleaning by using another type of a conventional pad.

FIG. 3A is a perspective view of a first embodiment of a tip cleaning device in accordance with the present invention.

FIG. 3B depicts an embodiment of bipolar cautery and tips thereof to be used with the tip cleaning device of FIGS. 3A and 4-6.

FIG. 4 is a top view of a second embodiment of a tip cleaning device in accordance with the present invention.

FIG. 5A is a cross sectional view of a third embodiment of a tip cleaning device in accordance with the present invention.

FIG. 5B is a cross sectional view of a fourth embodiment of a tip cleaning device in accordance with the present invention.

FIG. 6 is a cross section view of a fifth embodiment of a tip cleaning device in accordance with the present invention.

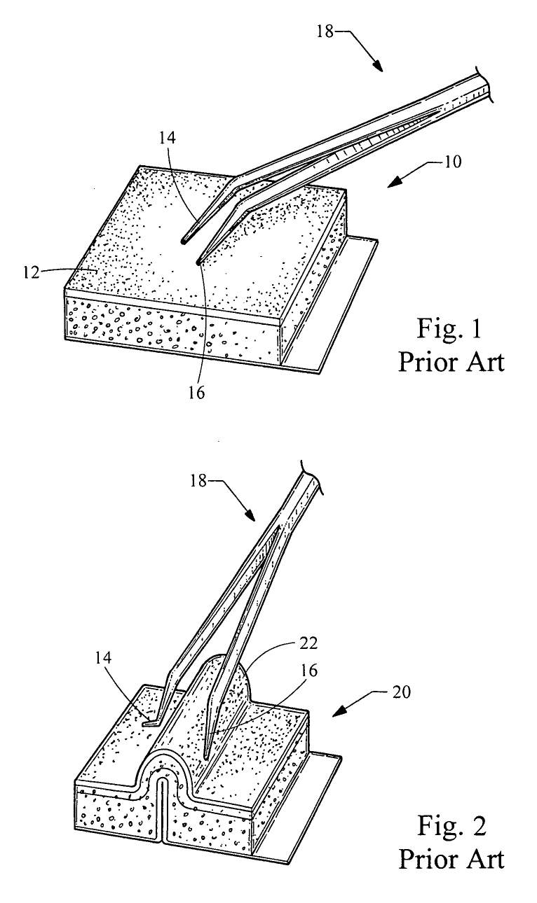

### DETAILED DESCRIPTION OF THE INVENTION

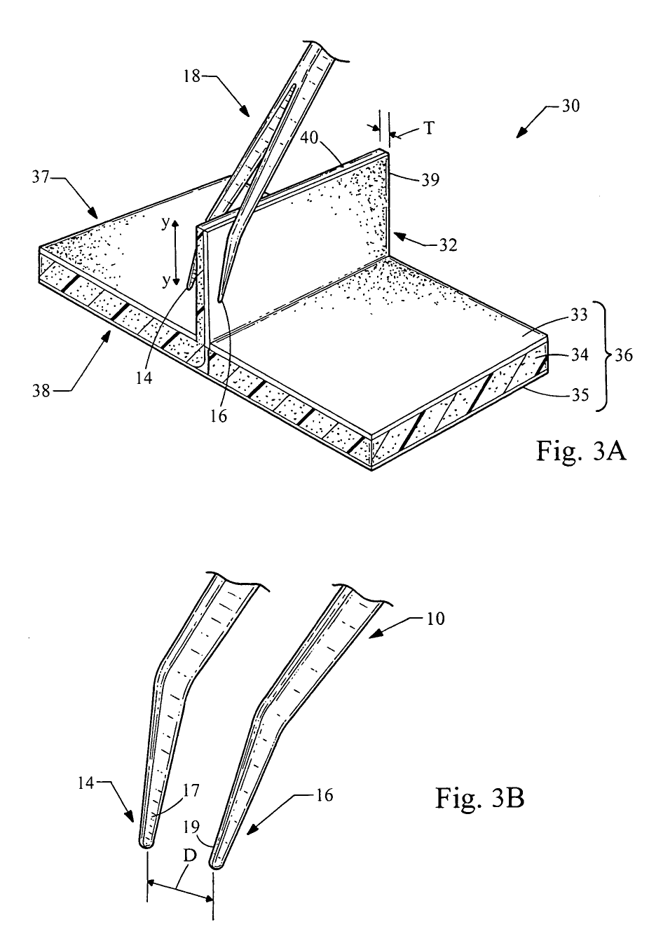

The present invention can be understood upon a review of the embodiments shown in FIGS. 3-6, wherein like elements are denoted by like numerals. For example, FIG. 3A shows a first embodiment of a tip cleaning device 30 for a bipolar cautery 18. The bipolar cautery 18 includes a pair of legs having a tip 14 and a tip 16. The bipolar cautery 18 may have various shapes, designs and sizes depending on the medical fields where it is used. FIG. 3B shows that the tip 14 and the tip 16 have inner surfaces 17 and 19, respectively. The inner surfaces 17 and 19 are spaced apart by a predetermined distance D, which is adjustable. As a result of cauterization, blood or tissues stick to one of the inner surfaces 17 and 19.

The tip cleaning device 30 includes a base 36 and an upstanding wall 32. The base 36 includes an upper surface 37 and a lower surface 38. As shown in FIG. 3A, the base 36 has three layers 33, 34 and 35. The layer 33 is made of an abrasive material and it may be used for cleaning the tips 14, 16, if necessary. The layer 33 may also be used to clean a unitary cautery tip. A top surface of the layer 33 defines the upper surface 37. The support layer 34 is made of a soft, elastic material, such as sponge. Alternatively, the support layer 34 can be made of plastic. If a plastic material is used, the support layer 34 forms a thin plastic plate. The layer 35 includes adhesive material, so that the base 36 is removably attachable to a working surface. The working surface may be any place where surgeons need to place the tip cleaning device 30. Specifically, a bottom surface of the adhesive layer 35 includes the adhesive material to be attached onto the working surface. The adhesive layer 35 is generally suitable for easy attachment to and easy removal from any type of working surfaces. A coating paper, a thin layer, or other structures may be used to protect the adhesive layer 35. For example, the coating paper is attached to the bottom surface of the adhesive layer 35 and a surgeon takes off the coating paper prior to attaching the cleaning device 30 to a working surface.

The three layers 33, 34 and 35 may be stacked together with adhesive material disposed therebetween. A bottom surface of the abrasive layer 33 does not have to be abrasive. For example, the bottom surface of the abrasive layer 33 may be smooth. In another embodiment, the support layer 34 may have an abrasive coating on its top surface and an adhesive coating on its bottom surface.

The upstanding wall 32 extends vertically upwardly from the upper surface 37 of the base 36. The upstanding wall 32 includes two exterior surfaces 39 and 40. On the surface 39 of the upstanding wall 32, abrasive material is disposed. The abrasive material includes grit abrasives, for example, about 200 grit abrasives. In alternative embodiments, the abrasive material will include coarser or finer grit abrasives depending on the desired cleaning. The surface 40 does not have any abrasive material and it is smooth. As previously stated, blood or tissues as a result of cauterization typically accumulate on only one cautery tip. Thus, the tip 14 without the blood or tissues does not need cleaning, whereas the tip 16 that accumulates blood or tissues requires the cleaning. Even if the tip 14 is rubbed against the surface 40, abrasion of the tip 14 is minimized because the surface 40 is smooth. Further, the tip 16 in need of cleaning is brought into contact with the abrasive surface 39, but it has little direct contact with the abrasive surface 39. Blood or tissues stuck to the tip 16 actually contact the abrasive surface 39. This feature increases the service life of the cautery 18 by minimizing the abrasion of the tips 14 and 16.

As shown in FIG. 3A, the upstanding wall 32 is formed integrally with the base 36. Alternatively, the upstanding wall 32 is attached on the center of the base 36 by an adhesive material. The upstanding wall 32 is perpendicular to the base 36, and alternatively, it may be angled between 0° and 90° relative to the base 36. The upstanding wall 32 is generally made of material that provides flexibility. The wall 32 can, therefore, easily be folded down by pressure for packaging and then be brought back in its shape and position when it is in use. When it is pressed down, the wall 32 may be positioned adjacent either side of the upper surface 37 of the base 36.

Referring to FIGS. 3A-3B, a tip cleaning operation is explained. The bipolar cautery 18 cauterizes tissues and the cauterized tissues stick to the tip 16 as the electric current flows from the tip 14 to the tip 16. To clean the cautery tips, a surgeon places the cautery legs so that they straddle the wall 32 as shown in FIG. 3A. A thickness T of the wall 32 is configured to be smaller than a distance D between the tips 14, 16. In this embodiment, the thickness T of the upstanding wall 32 is about 3 mm and the distance D is about 10 mm. In another embodiment, the wall 32 is thicker or thinner, corresponding to the sizes of bipolar cautery devices. The thickness T ranges between 1 mm and 5 mm. In addition, the distance D of the commonly used bipolar cautery devices varies between 5 mm and 10 mm. For a bipolar cautery used for cosmetic surgery, the distance D can be smaller. A surgeon squeezes the cautery legs lightly on both sides with his or her fingers and rubs them against the upstanding wall 32 up and down. The inner surface of the cautery device 18 adjacent to the surface 39 is thus cleaned. Because tip inner surfaces 17, 19 are in direct contact with the surfaces 39, 40, a surgeon can easily clean the tip inner surfaces. The abrasive layer 33 of the base 36 may be used to quickly clean the tips 14, 16. Because the upstanding wall 32 is thinner than the distance D, the cautery legs can move along an axial direction indicated as the line Y-Y in FIG. 3A. The axial Y-Y direction here is perpendicular to the base 36. The tips 14, 16 can avoid distortion and deformation that arise out of a nonaxial contact between the tips and the cleaning device.

Occasionally, if surgery involves a large amount of blood, blood or coagulated tissues may stick to the tip 14. To clean the tip 14, a surgeon simply switches the position of the bipolar cautery 18 relative to the tip cleaning device 30 so that the tip 14 faces the abrasive layer 39. A surgeon then cleans the tip 14 in the same manner as described above.

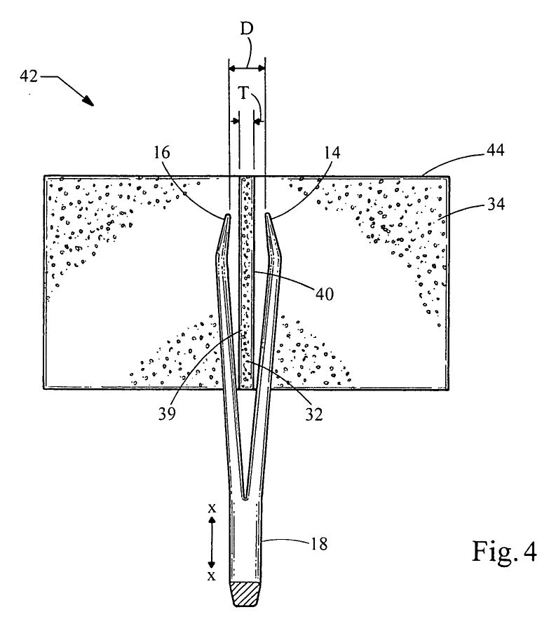

FIG. 4 illustrates another example of a tip cleaning operation of a second embodiment of a tip cleaning device 42. In this embodiment, a base 44 does not have an abrasive layer, such as the abrasive layer 33 described in the first embodiment of FIG. 3A. The support layer 34 that is made of sponge becomes a top layer. Alternatively, the support layer 34 may be made of plastic material. To clean the cautery tips in this embodiment, a surgeon places the bipolar cautery 18 adjacent the upstanding wall 32 so that the upstanding wall 32 is sandwiched by the cautery legs. A surgeon moves the cautery legs in a direction parallel to the base 44, which is indicated as the line X-X in FIG. 4. The tips 14, 16 avoid distortion and deformation that arise out of nonaxial contacts between the tips and the cleaning device, regardless of differences in the axial direction. In addition, manufacturing costs may be reduced by not having an abrasive layer, such as the abrasive layer 33 shown in FIG. 3A.

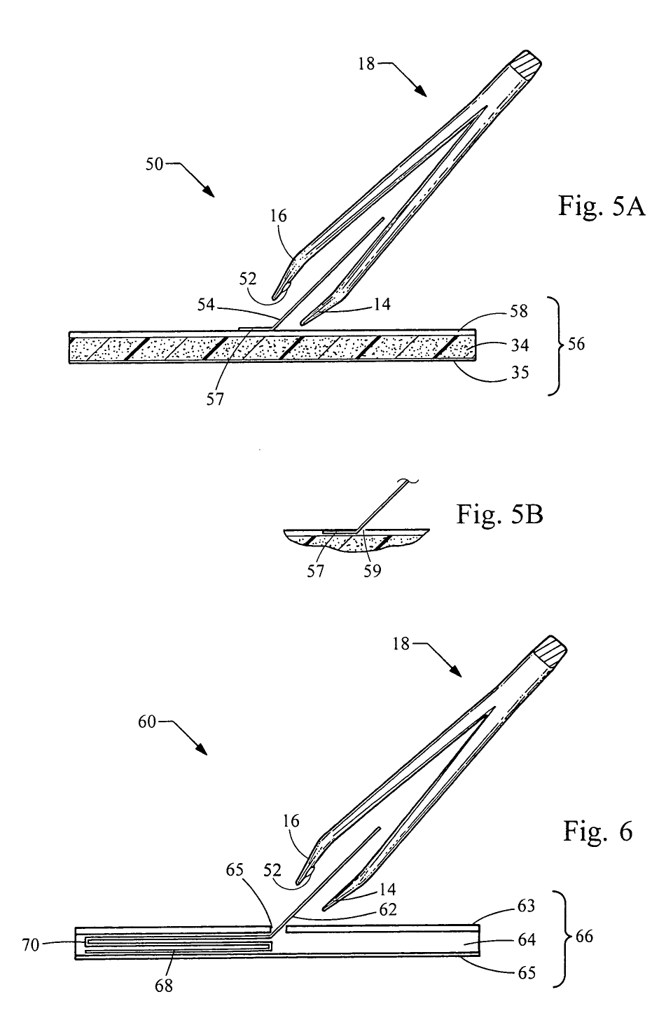

FIG. 5A illustrates a third embodiment of a tip cleaning device 50. The tip cleaning device 50 includes a cleaning sheet 54, which extends upwardly from the base 36 at an angle, which ranges between 0° and 90°. Preferably, the cleaning sheet 54 is angled at 30° to 60° relative to the base 36. Surgeons may adjust the angle of the cleaning sheet 54 relative to the base 36 depending on their preference and need. Because the cleaning sheet 54 upwardly sticks out at an angle, the bipolar cautery 18 is easily accessible to the cleaning sheet 54 for cleaning. Because blood or tissue 52 sticks to the tip 16 only, a surface of the cleaning sheet 54 corresponding to the tip 16 includes abrasive material disposed thereon. The other surface of the cleaning sheet 54 does not have an abrasive material and may be smooth. A base 56 supports the cleaning sheet 54 by releasably holding the sheet 54 to the base 56. In one embodiment shown in FIG. 5A, a flange 57 is integrally formed at a bottom edge of the cleaning sheet 54 and attached to a top layer 58 of the base 56 by adhesive material. The top layer 58 may be an abrasive layer described in connection with FIG. 3A. Alternatively, instead of the cleaning sheet 54, the top layer 58 includes an elongated area having adhesive material disposed thereon, thereby attaching the cleaning sheet 54 thereto. In another embodiment shown in FIG. 5B, the top layer 58 may include a slit 59 to receive the flange 57. The slit 59 is configured to be narrow so that once the flange 57 is inserted into the slit 59, it should not be easily moving out of the slit 59. In addition, the flange 57 may be configured to include an adhesive material thereon to further secure the connection between the cleaning sheet 54 and the base 56 via the slit 59.

In FIGS. 5A-5B, a new cleaning sheet may be placed onto the top layer 58 of the base 56 at the same position of a previously removed used cleaning sheet 54 by either attaching a flange of the new cleaning sheet such as the flange 57 onto the top surface 58 of the base 56 with an adhesive material or inserting it into the slit 59. By using the cleaning sheet 54 of FIGS. 5A-5B, it is easy to quickly remove a used cleaning sheet with a new cleaning sheet 54 and replace it when a large amount of blood is involved in surgery and reduce manufacturing expenses. Furthermore, where the tip 14 needs cleaning due to the large amount of blood, a surgeon simply turns around the bipolar cautery 18 so that the tip 14 can be rubbed against the abrasive side of the cleaning sheet 54.

A tip cleaning operation using the tip cleaning device 50 is performed in a manner similar to those described above in connection with the first and the second embodiments and FIGS. 3 and 4.

FIG. 6 shows a fifth embodiment of a tip cleaning device 60. The tip cleaning device 60 has a first cleaning wall, such as sheet 62 and at least one second cleaning wall, such as sheet 68. A surface of the first cleaning sheet 62 facing the inner surface of tip 16 includes abrasive material, and the other surface is smooth. The first cleaning sheet 62 protrudes through an elongated slit 65 upwardly from a top surface 63 of a base 66. The second cleaning sheet 68 is stored in a chamber 64 formed within the base 66. The base 66 includes the top surface 63 and a lower surface 65, and the chamber 64 is formed therebetween. The second cleaning sheet 68 is severably connected with the first cleaning sheet 62. For example, there is an elongated perforated line for easy separation between the first cleaning sheet 62 and the second cleaning sheet 68. The elongated slit 65 provides a passageway to the second cleaning sheet 68.

A surgeon cleans the tips 14, 16 by placing the cautery 18 to straddle the first cleaning sheet 62 and cleans the cautery 18 in a manner similar to that described above with respect to the embodiments of FIGS. 3 and 4. After cleaning, the surgeon replaces the used cleaning sheet 62 with a new cleaning sheet 68. When the first cleaning sheet 62 is lifted upwardly for removal, the second cleaning sheet 68 is pulled out of the chamber 64. The second cleaning sheet 68 subsequently replaces the first cleaning sheet 62 and a surgeon separates the first cleaning sheet 62 from the second cleaning sheet 68 by tearing along the elongated perforated line formed between sheets 62 and 68. The tip cleaning device 60 can provide surgeons with an effective way to clean the bipolar cautery tips during operation involving a large amount of blood by easily replacing an used cleaning sheet with a new cleaning sheet. In addition, where two tips 14, 16 need cleaning due to the large amount of blood, a surgeon can easily perform cleaning by simply turning around the bipolar cautery 18 so that either tip 14 or tip 16 can be rubbed against the abrasive side of the first cleaning sheet 62.

By using the described tip cleaning devices, a bipolar cautery can maintain well-matched tips after the repeated cleaning, thereby lengthening the service life of the bipolar cautery and saving expenses for surgeons and patients.

Although the various embodiments of the invention have been described in connection with surgical bipolar cautery, the invention is not so limited. The invention is readily applicable to other similar devices or instruments that require cleaning of the tips.

The various embodiments do not represent the scope of the invention. For example, it may be apparent to those having ordinary skill in the art that modifications and changes may be made with the invention. It is therefore intended in the appended claims to cover all such changes and modifications that fall within the true spirit and scope of the invention.

I claim:

1. A cleaning device, comprising:
a base including an upper surface and a lower surface; and,
an upstanding wall extending upwardly relative to the upper surface of the base, the wall including a first surface and a second surface, wherein the first surface includes an abrasive material disposed thereon and the second surface does not include an abrasive material; and,
wherein a thickness of the wall is configured to be less than about 3 mm.

2. The cleaning device of claim 1, wherein the base further comprises an abrasive layer that defines said upper surface.

3. The cleaning device of claim 1, wherein the base further comprises a support layer.

4. The cleaning device of claim 3, wherein the support layer is made of elastic material.

5. The cleaning device of claim 3, wherein the support layer is made of plastic material.

6. The cleaning device of claim 1, wherein the base further comprises an adhesive layer.

7. The cleaning device of claim 6, wherein the adhesive layer defines the lower surface.

8. The cleaning device of claim 1, wherein the abrasive material includes a quantity of grit abrasives.

9. The cleaning device of claim 1, wherein the upstanding wall is made of flexible material that can be folded down to be adjacent the upper surface.

10. The cleaning device of claim 1, wherein the upstanding wall is perpendicular to the upper surface of the base.

11. The cleaning device of claim 1, wherein the upstanding wall is angled relative to the upper surface of the base and the angle ranges between 0° and 90°.

12. The cleaning device of claim 1, wherein the upstanding wall includes a cleaning sheet and the base releasably holds the cleaning sheet.

13. The cleaning device of claim 12, wherein the cleaning sheet is removably attachable to the base.

14. The cleaning device of claim 12, wherein the cleaning sheet further comprises a flange at a bottom edge thereof and attached to the upper surface of the base.

15. The cleaning device of claim 12, wherein the cleaning sheet further comprises a flange at a bottom edge thereof and the base further comprises a slit to receive the flange on the upper surface.

16. The cleaning device of claim 12, wherein the base further comprises an elongated adhesive area on the upper surface thereof to attach the cleaning sheet thereto.

17. A cleaning device, comprising:
a first cleaning sheet including a first surface and a second surface, the first surface having abrasive material disposed thereon; and,
a support releasably holding the first cleaning sheet, the support comprising: an upper surface; a lower surface; a chamber formed between the upper surface and the lower surface, the chamber storing a second cleaning sheet; and a slit located on the upper surface and connected into the chamber, the slit providing a passageway to the second cleaning sheet.

18. The cleaning device of claim 17, wherein the second surface of the first cleaning sheet does not include an abrasive material.

19. The cleaning device of claim 17, wherein a thickness of the first cleaning sheet is configured to be less than about 3 mm.

20. The cleaning device of claim 17, wherein the first cleaning sheet and the second cleaning sheet are severably connected to one another.

21. The cleaning device of claim 17, wherein when the first cleaning sheet is removed, the second cleaning sheet subsequently replaces the first cleaning sheet.

22. The cleaning device of claim 17, wherein the first cleaning sheet extends upwardly at a predetermined angle relative to the upper surface of the support.

23. A method for cleaning tips of a bipolar cautery having a pair of legs, each leg including a tip on an end thereof, comprising:
(a) placing the legs of the bipolar cautery adjacent a wall extending upwardly relative to a base;
(b) squeezing the legs on both sides toward the wall; and,
(c) rubbing inner surfaces of the tips against two surfaces of the wall according to an axial direction of the bipolar cautery so that only one of the inner surfaces engages an abrasive material of the wall.

24. The method of claim 23, wherein (a) includes placing the legs of the bipolar cautery to straddle the first upstanding wall extending perpendicular to the base.

25. The method of claim 23, wherein (a) includes placing the legs of the bipolar cautery to straddle the first upstanding wall extending angled relative to the base, the angle being between 0° and 90°.

26. The method of claim 23, wherein (a) includes placing the legs of the bipolar cautery to sandwich the first upstanding wall in a direction parallel to the base.

27. The method of claim 23, further comprising:
(d) switching position of the tips relative to the wall so that the other inner surface engages the abrasive material of the wall.

28. The method of claim 23, further comprising:
(d) removing the wall used to clean the tips from the base by lifting the wall upwardly.

29. The method of claim 28, further comprising:
(e) placing another wall onto an upper surface of the base at the same position of the used wall, wherein the another wall includes a flange at the bottom edge thereof and the flange is either attached onto the upper surface of the base by adhesive material or inserted into a slit formed on the upper surface of the base.

30. The method of claim 28, further comprising:
(e) replacing the wall used to clean the tips by another wall stored in a chamber formed within the base, wherein the used wall is severably connected with the another wall and when the used wall is lifted up, the another wall is pulled out of the chamber.

31. The method of claim 30, further comprising:
(f) separating the used wall from the another wall by tearing along an elongated perforated line between the walls.
